(19) United States
(12) Patent Application Publication
(10) Pub. No.: US 2026/0365453 A1
(43) Pub. Date: Nov. 19, 2026

(54) METHOD AND APPARATUS FOR AUTOMATICALLY UNLOADING PACKAGES FOR AUTOMATIC ORDER PICKING

(71) Applicant: Dematic GmbH, Heusenstamm (DE)

(72) Inventor: Hans Christoph Meurer, Framersheim (DE)

(21) Appl. No.: 19/132,187

(22) PCT Filed: Nov. 23, 2023
(86) PCT No.: PCT/EP2023/082829

§ 371 Date: May 22, 2025

(30) Foreign Application Priority Data
Nov. 25, 2022 (DE) 10 2022 131 230.5

(51) Int. Cl. B65G 47/68; B65G 47/31; B65G 47/82

(52) U.S. Cl. CPC B65G 47/682; B65G 47/31; B65G 47/82; B65G 2203/0291

(57) ABSTRACT

A method and apparatus for automatically unloading packages for automatic order picking, where a plurality of packages are provided lying on a tray upstream of further processing, an unloading device is used to unload all the packages from the tray there and packages that are not required for subsequent further processing are loaded back onto a tray by a loading device such that only required packages are provided.

### CROSS REFERENCE TO RELATED APPLICATION

The present application claims the priority benefits of International Patent Application No. PCT/EP2023/082829, filed Nov. 23, 2023.

### BACKGROUND AND FIELD OF THE INVENTION

The invention relates to a method and an apparatus for automatically unloading packing pieces.

Nowadays, in distribution logistics, ever greater demands are placed on the order-picking process. It is thus necessary to develop order-picking systems which process orders automatically without manual intervention.

Thousands of different products (or packing pieces) with a wide variety of different characteristics (size, shape, weight, dimensions, surfaces, strength, compressibility, etc.) must be automatically picked by means of such systems. In order to handle this wide variety of packing units uniformly, it is known to use trays to store and transport them.

The automatic stacking of packing pieces on a base or a support, in particular a pallet or roll car, to form a stack for subsequent dispatch, i.e. “palletising”, is known per se. In this regard, individual packing pieces of uniform sizes or uniform dimensions are placed at arithmetically determined locations by means of robots, grippers, etc.

In contrast, the process of automatically loading a load carrier with packing pieces of different characteristics for forming a stack is so-called automatic “mixed-case” palletising.

EP 1 462 394 B1 discloses an apparatus for automatically loading a load support with load stack-forming packing units, i.e. an apparatus for palletising. In this apparatus, a packing unit, lying on a table, is moved by a pusher along the broad side of the pallet to be loaded, until the loading coordinates in the X direction are reached. Then, a further pusher and a loading tongue simultaneously push the packing unit in the direction of the load depth across the pallet until the loading coordinates in the Z direction are reached. Then, the loading tongue moves back and the pusher remains stationary and is used as a scraper so that the packing unit is set down on the pallet at the desired location in a “free falling” manner. The stack being formed is supported on the three other sides by a loading aid. It is thus stacked virtually “against the wall”. However, moving on the packing table is time-consuming and has disadvantages when forming the packing pattern owing to the limited accessibility. Moreover, it is necessary for the loading tongue and the scraper/pusher to move simultaneously in the X direction. Also, only one packing unit can be “processed” sequentially.

In the system or apparatus of EP 1 462 394 B1, for better and simplified handling the different articles or packing units are each stored in a singulated manner on trays and supplied for palletising. In the palletising machine itself, the trays are unloaded and the packing units are ultimately palletised individually. Therefore, this apparatus can only deal with individually loaded trays.

Although the individual loading of the trays has handling advantages, in particular in the case of automatic tray unloading, it is associated with a poor utilisation of space in the overall system. Accordingly, a large number of trays are also required, which adds costs and complexity to the feed section in order to provide these, and the throughput of the palletising device is limited accordingly.

Systems are known in which a plurality of packing units per tray are stored and are moved therewith. For instance, the company Knapp discloses, at https://youtu.be/UR8HXvvM6CA at 2:30 and the company Vanderlande discloses at https://youtu.be/FwagVpkDKtQ at 2:10 the targeted unloading of individual desired packing units from a tray loaded with multiple items. The targeted unloading is costly and complex because the position of the packing units on the tray and with respect to each other has to be defined and known and the push-off device has to be actuated accordingly.

It is known that the automated further handling of packing pieces mostly requires that the packing pieces are provided without trays, i.e. unloaded, and possibly singulated.

### SUMMARY OF THE INVENTION

The present invention provides a method and an apparatus for automatic unloading of packing pieces for automatic order picking, which method and apparatus permit, in a flexible manner, targeted provision of packing pieces from trays loaded with multiple items.

In accordance with the invention, it has been recognised that when initially all packing pieces are unloaded from a tray loaded with multiple items and then the packing pieces which are not required are reloaded onto a tray, it becomes possible to combine, in a flexible manner, the advantages of multiple loading with those of individual provision for palletising. For instance, the method in accordance with the invention is more tolerant with respect to the location and position and orientation of the packing pieces with respect to each other on the tray and also with respect to the position of the tray in relation to the scraper since all the packing pieces are unloaded and thus become capable of being handled (and possibly oriented).

In other words, in accordance with the invention, only the packing pieces required for order picking are not reloaded onto a tray but provided to the palletiser arranged downstream.

The reloading occurs in the same apparatus in close proximity and is thus relatively compact. The packing pieces are thus not first placed into storage and then removed from storage or distributed via relatively long conveying technology and handled elsewhere in the order-picking system, but rather directly in the apparatus. It is thus a module for providing the packing pieces required for order picking.

Preferably, provision is also thus made that the same tray is used for the reloading. In principle, another tray or even transport means could also be loaded. This can be provided spatially at the same location or separately, e.g. somewhat downstream, in particular when for example an orientation unit is provided between the unloading device and the loading device.

In order to simplify the reloading of the packing pieces which are not required, and possibly to singulate the required packing pieces at the same time (triggering the grouping or orienting), the required packing pieces can, by gap formation in an orientation unit, be separated from the packing pieces not required for the subsequent palletising prior to the reloading thereof. The gap formation can be effected by means of gapping methods analogous to sorting technology. The required packing pieces can thus be singulated by gap formation for subsequent further handling, e.g. palletising.

Trays typically have a rectangular surface and can thus be transported with the short or long side at the front. Unloading and loading are simplified if the trays are oriented upstream of the unloading device such that the short side thereof lies at the front in the transport direction. Therefore, unloading or loading can occur via the longer broad side.

Safe and simple unloading can be effected e.g. by laterally transferring, e.g. by pushing-off, onto a parallel path. For this purpose, trays can be unloaded from a tray feed section by means of the unloading device onto a discharge path extending in parallel.

For this purpose it is preferred if the surface of the discharge path in the region of the unloading and in the region of the reloading is on a similar height level as the surface of the tray feed section. In particular, a raised packing piece should lie with its base at the height of the discharge path in order for the unloading and reloading to function without any disruptions. It is possible to increase the throughput if trays are unloaded onto a discharge path alternately from two parallel tray feed sections in an alternating manner by means of the unloading device. It is also possible for loading and unloading to occur simultaneously with two tray feed sections.

A possible source of errors is eliminated if the loading pattern of packing pieces when loading trays upstream of the unloading device is selected such that the packing piece row is stabilised by the tray edges. If required, the packing pieces can be oriented in a row. Therefore, during unloading, common handling is improved e.g. by laterally pushing-off without wedging the packing pieces together. It is preferred if the packing pieces are oriented at the edge of the respective tray.

Alternatively, an error routine can begin if wedging occurs because a scraper pushes a packing piece which in turn also pushes another piece and this results in clamping, wedging, etc. Such an error routine can comprise reversing the conveyors, changing the speeds of the conveyors, etc. in order nevertheless to achieve gap formation.

An apparatus in accordance with the invention of an order-picking system for unloading trays loaded with packing pieces and for the reloading of trays, in which a plurality of packing pieces are provided upstream lying on a tray, comprises a first supply conveyor, a discharge path extending at least partially parallel thereto, and an unloading device, wherein trays to be unloaded are supplied on the first supply conveyor. By means of the unloading device, all the packing pieces are transferred from the tray, which lies on the supply conveyor, onto the discharge path. Packing pieces not required for the subsequent (downstream) further handling are guided back from the discharge path onto a tray in an internal loading device (i.e. one which is arranged in the same apparatus) and so only packing pieces required for order picking remain on the discharge path and are provided to the subsequent further handling by means of the discharge path for order picking.

Since the unloading device and also the loading device are arranged spatially close to each other, because they are positioned in the same apparatus, the apparatus is also compact. Such an apparatus is suitable in particular for automatically providing packing pieces for multi-layer stacking of a support with packing pieces in a subsequent palletising.

Appropriate trays have a frame with a peripheral raised edge and a base having at least one aperture, and therefore all the packing pieces can be raised from beneath through the at least one aperture by means of a lifting device to a level above the edge and the discharge path, so that the unloading device can unload the packing pieces onto the discharge path using an (unloading) pusher. Although alternatives are feasible, such as robot-supported gripping etc., these are substantially more complex and expensive and are in most cases more complex in terms of control technology in the case of a very broad range of package types and shapes.

Preferably, the apparatus comprises a loading device for transferring the packing pieces which are not required from the discharge path onto a tray on the first supply conveyor. This can be configured analogously to the unloading device. For instance, a pusher or reloading pusher can also be used for this purpose.

Both the (unloading) pusher and also the (reloading) pusher can be suspended on guides which are fastened above the supply conveyor or discharge path. Both are preferably arranged in the same location and share a discharge path which can possibly also be used for orienting (gap formation).

It is possible to increase the throughput if trays are unloaded onto a discharge path alternately from two parallel tray feed sections in an alternating manner by means of the unloading device. For this purpose, the unloading device can comprise two corresponding (unloading) pushers. It is also possible for loading and unloading to occur simultaneously with two tray feed sections.

In a preferred embodiment, the discharge path of the apparatus has a sensor-controlled, multi-zone conveyor arrangement, by means of which the required packing pieces can be separated from the packing pieces which are not required and also singulated. The conveyor arrangement can include e.g. roller conveyor zones which are arranged one behind another and are separately driven and controllable. A suitable sensor is a photocell arrangement which can detect the start and end of a packing piece. Therefore, passage of the packing pieces can be recognised.

Preferably, the sensor-controlled, multi-zone conveyor arrangement of the discharge path includes several successive conveyor zones, wherein the packing piece sensor is arranged in the region of a second conveyor zone which is shorter than a first and third conveyor zone and in each case accelerates one or more packing pieces in a controlled manner for separation (gap formation). This acceleration can be effected via a controller using the packing piece sensor and so the required packing pieces are separated by the targeted acceleration from the packing pieces which are not required. The loading device can then load the packing pieces which are not required immediately from the discharge path back onto a tray or the same tray.

If the apparatus comprises two tray feed sections extending in parallel in the region of the unloading device and enclosing the discharge path therebetween at that location, wherein the unloading device comprises a respective unloading apparatus associated with the tray feed section and the discharge path includes a loading device active on both sides, then the throughput of the apparatus can be increased by parallelised sequences.

Further details of the invention will become clear from the following description of exemplified embodiments by reference to the drawings.

### BRIEF DESCRIPTION OF THE DRAWINGS

FIGS. 1-4 each show a schematic plan view of a first embodiment of the invention in different phases of the unloading or reloading;

FIGS. 5-10 each show a schematic plan view of a second embodiment of the invention in different phases of the unloading or reloading; and

FIG. 11 shows perspective views of a tray in the transport position and the loading or unloading position.

### DESCRIPTION OF THE PREFERRED EMBODIMENTS

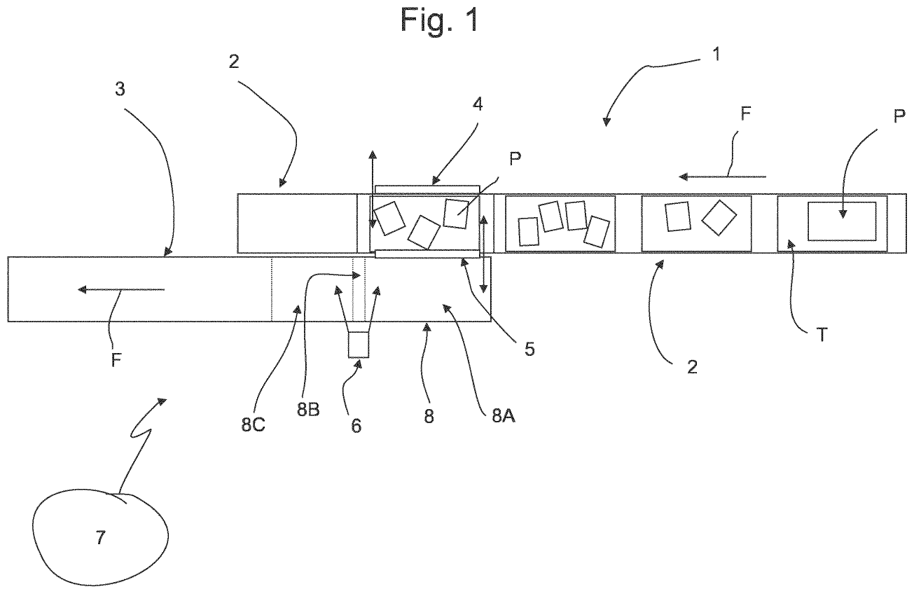

FIGS. 1 to 4 show a first embodiment of an apparatus 1 for unloading trays T loaded with a plurality of packing pieces P for automatic provision of packing pieces P for downstream stacking in multiple layers (order picking), downstream in the conveying direction F, of a support (e.g. pallet or roll car) with the packing pieces. The apparatus 1 includes a first supply conveyor 2, a discharge path 3 extending at least partially in parallel therewith and an unloading device 4 and a loading device 5. In addition, a photocell is provided as a packing piece sensor 6 and a controller 7 for the apparatus.

The first supply conveyor 2 is a roller conveyor having a conveying direction F. This is supplied with the loaded trays from a store, not shown. Optionally, an apparatus for orienting the trays T so that the short side thereof lies at the front in the transport direction F can be arranged upstream. Also upstream, an optional apparatus for orienting the plurality of packing pieces P in a row at the edge of the tray can be arranged.

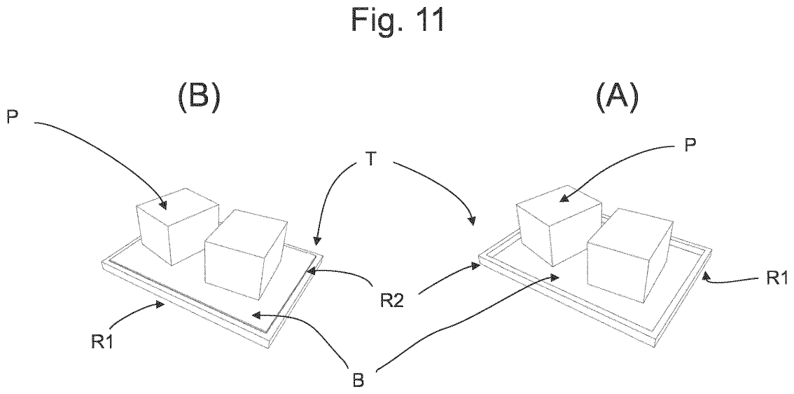

The trays T have, as known, a frame R1 with a peripheral raised edge R2 and a base B with at least one aperture. Packing pieces P lying on the base are raised from beneath through the at least one aperture by means of a lifting device, not shown, to a level above the edge R2 (cf. FIG. 11), so that the unloading device 4 can unload the packing pieces P onto the discharge path 3 in the transfer region 8. The surface of the discharge path 3 in the transfer region 8 (of the unloading and in the region of the reloading) is arranged at the same height level as the surface of the raised base B.

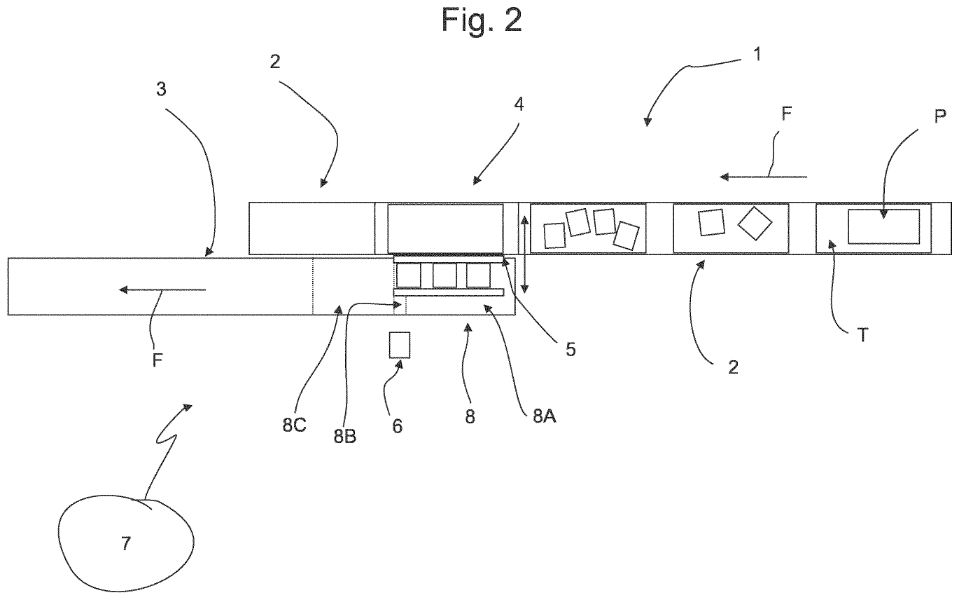

The unloading device 4 is configured as a push-off device or unloading pusher which can be actuated in a controlled manner and pushes all the packing pieces P laterally from the tray P onto the discharge path 3 in the transfer region 8 (FIG. 2).

The discharge path 3 is configured in the transfer region 8 as a sensor-controlled, multi-zone conveyor arrangement and so required packing pieces P are separated from the packing pieces which are not required. For that purpose, the sensor-controlled, multi-zone conveyor arrangement of the discharge path 3 includes three successive conveyor zones 8a, 8b, 8c, wherein the packing piece sensor 6 is arranged in the region of a second conveyor zone 8b which is shorter than a first and third conveyor zone 8a, 8c and in each case accelerates one or more packing pieces in a controlled manner for separation.

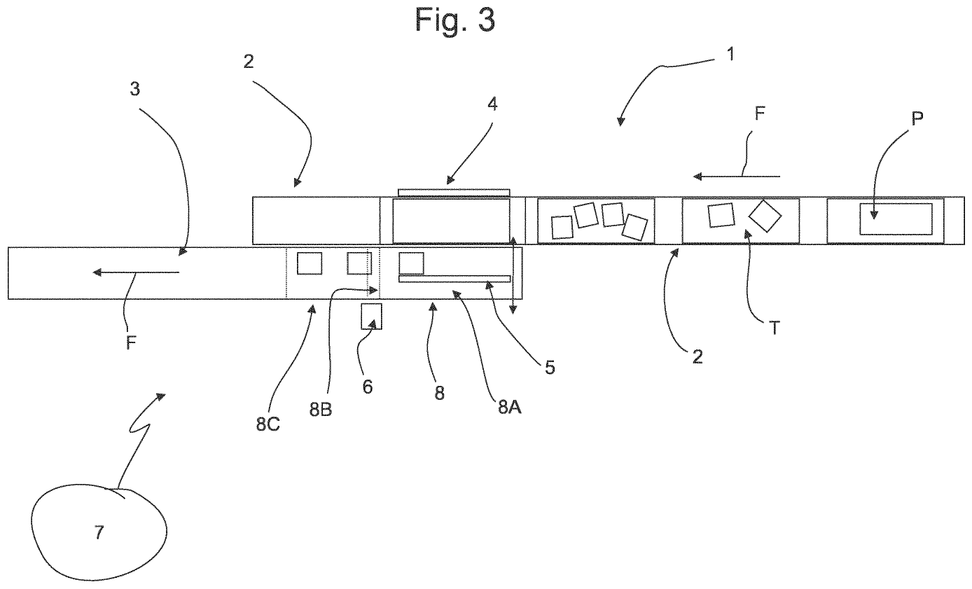

The second conveyor zone has a higher speed than the first conveyor zone and so the acceleration separates the packing piece entering the zone from the remaining packing pieces and thus permits the gap formation (FIG. 3). The conveyor arrangement is roller conveyor zones which are arranged one behind another and are separately driven and controllable.

A suitable packing piece sensor 6 is a photocell arrangement which can detect the start and end of a packing piece. Therefore, passage of the packing pieces can be recognised.

Therefore, all the packing pieces P are transferred by means of the unloading device 4 from the tray T on the supply conveyor 2 onto the discharge path 3.

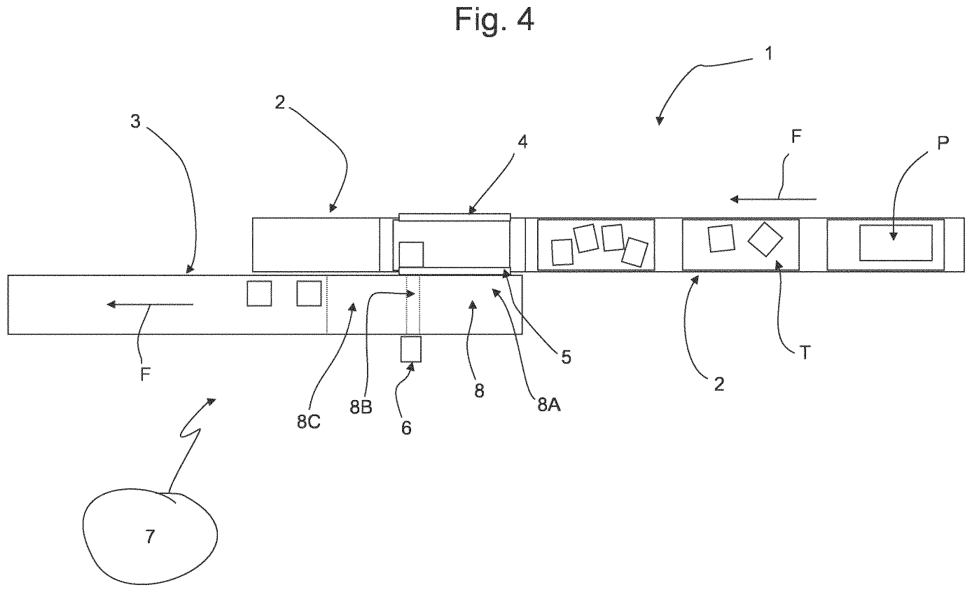

Packing pieces not required for subsequent further handling are guided from the discharge path 3 onto a tray (cf. FIG. 4) and so only required packing pieces remain on the discharge path and are provided for subsequent palletising or order picking by means of the discharge path 3. For this purpose, the loading device 5 of the apparatus 1 is likewise configured as a push-off device or reloading pusher S which can be actuated in a controlled manner and pushes all of the packing pieces P which are not required laterally from the transfer region 8 of the discharge path 3 back to the same tray T (FIGS. 3 and 4). The base B of the tray T is then lowered so that only the edge R2 has to be overcome (cf. above). The loading device 5 and unloading device 4 are thus arranged spatially in proximity to each other and are not separate.

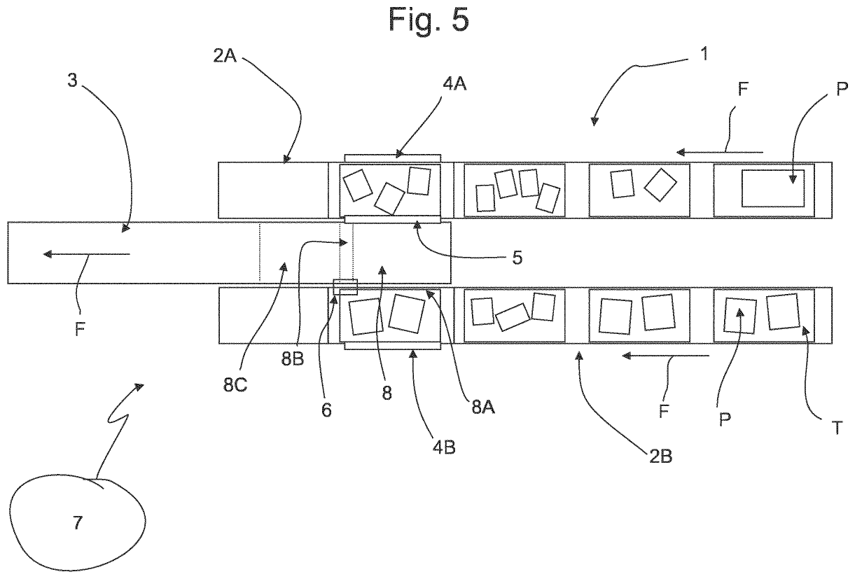

FIGS. 5-10 show an expanded variant which differs from the previously described embodiment by virtue of the fact that two tray feed sections 2A, B extending in parallel in the region of the unloading device 4 are provided and enclose the discharge path 3 therebetween at that location, wherein the unloading device 4 comprises a respective unloading apparatus 4A, B associated with the tray feed section 2A, B and the discharge path 3 includes a loading device 5 active on both sides, and so the throughput of the apparatus can be increased by parallelised sequences. Therefore, a tray can be unloaded on one tray feed section and a tray can be reloaded on the other tray feed section at the same time.

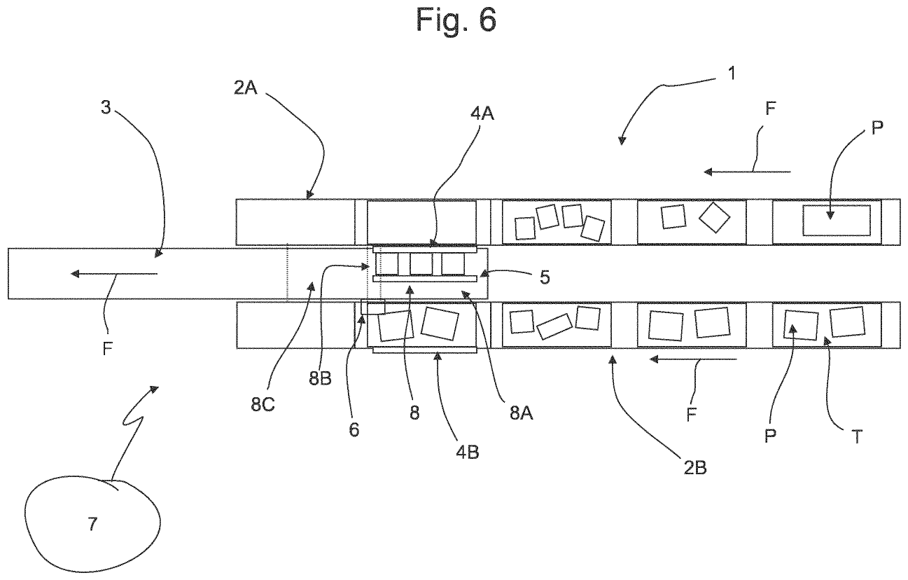

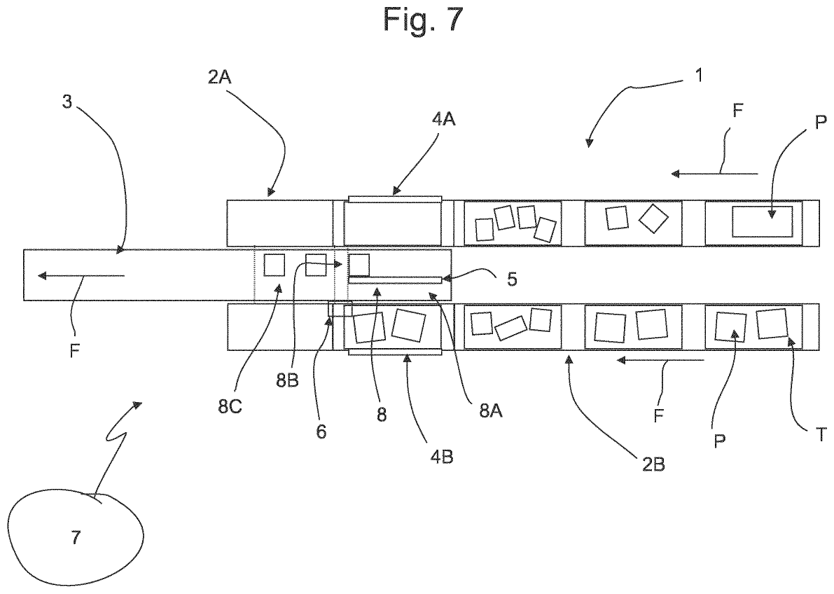

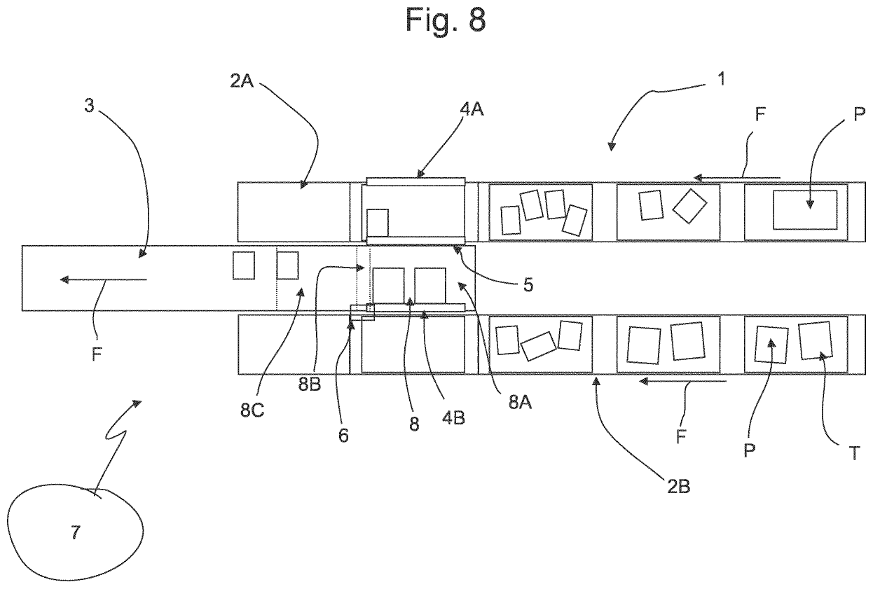

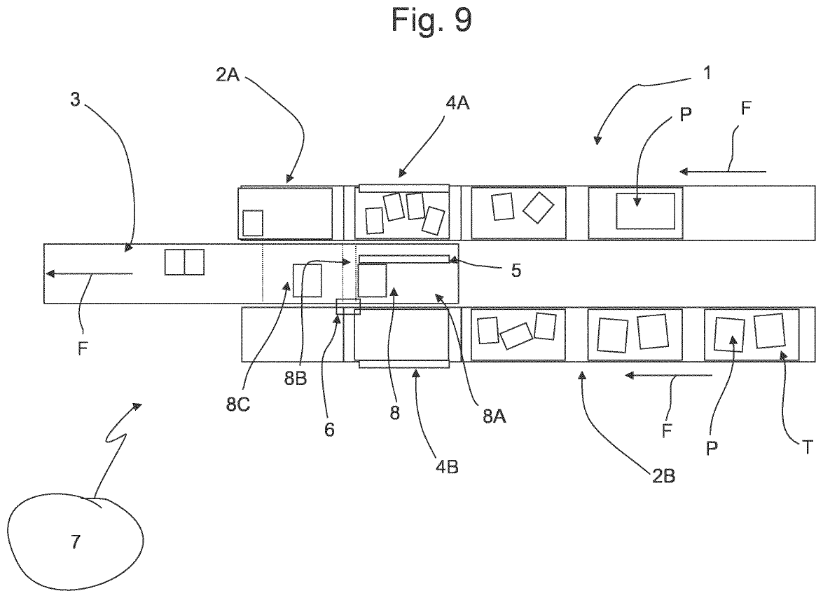

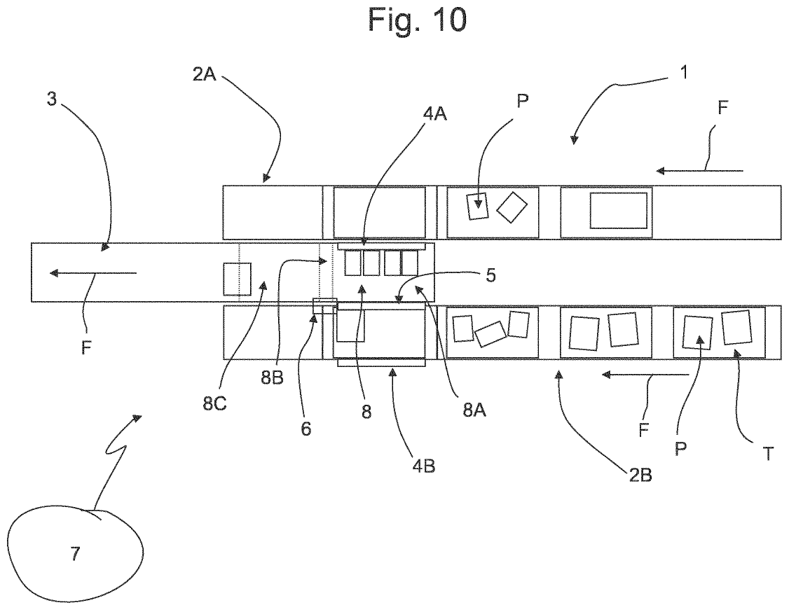

In the present example, initially the tray T is unloaded on the tray feed section 2A, wherein the loading device 5 is pre-positioned (FIG. 6). Then, the gap formation or separation of the required packing pieces P from the packing pieces which are not required (FIG. 7) and the reloading by means of the loading device 5 onto the same tray T on the tray feed section 2A (FIG. 8) are effected, as above. Simultaneously therewith, the tray is unloaded from the other tray feed section 2B by means of the unloading device 4B (FIG. 8). Then, gap formation (FIG. 9) and simultaneous reloading or unloading (FIG. 10) are again effected. It can be seen how the loading device 5 reloads the packing pieces P alternately to the tray feed section 2A and 2B.

The packing piece sensor 6 is in the present case is located above, so that it is not disruptingly in the way.

FIG. 11 shows a tray T having a frame R1, a peripheral raised edge R2 and a base B, loaded with two packing pieces P, in a transport position with non-raised base B (FIG. 11A) and an unloading position with raised base B (FIG. 11B).

1. A method for automatic unloading of packing pieces for automatic order picking, in which a plurality of packing pieces are provided lying on a tray upstream of further handling, said method comprising:
unloading all the packing pieces from the tray by an unloading device; and
reloading packing pieces onto a tray that are not required for the subsequent further handling by a loading device so that only packing pieces required for order picking are provided, wherein the unloading device and reloading device are arranged in the same apparatus.

2. The method as claimed in claim 1, wherein the same tray is used for the reloading.

3. The method as claimed in claim 2, wherein the required packing pieces are separated by gap formation from the packing pieces not required for the subsequent further handling prior to the reloading thereof.

4. The method as claimed in claim 1, wherein the trays are oriented upstream of the unloading device such that the short side thereof lies at the front in the transport direction.

5. The method as claimed in claim 1, wherein trays are unloaded from a tray feed section by the unloading device onto a discharge path extending in parallel.

6. The method as claimed in claim 5, wherein the surface of the discharge path in the region of the unloading and in the region of the reloading is at a similar height level as the surface of the tray feed section.

7. The method as claimed in claim 1, wherein trays are unloaded on a discharge path alternately from two parallel tray feed sections in an alternating manner by the unloading device.

8. The method as claimed in claim 1, wherein loading and unloading are effected simultaneously with two tray feed sections.

9. The method as claimed in claim 1, wherein the required packing pieces are singulated by gap formation for subsequent palletising.

10. The method as claimed in claim 1, wherein the loading pattern of packing pieces when loading trays upstream of the unloading device is selected such that the packing piece row is stabilised by tray edges and/or the plurality of packing pieces are oriented in a row upstream of the unloading device.

11. An apparatus of an order-picking system for unloading trays loaded with packing pieces and for the reloading of trays, in which a plurality of packing pieces are provided upstream lying on a tray, wherein the apparatus comprises:
a first supply conveyor and a discharge path extending at least partially parallel thereto; and
an unloading device;
wherein trays to be unloaded are supplied on the first supply conveyor, and wherein the unloading device is configured to transfer all the packing pieces from the tray on the supply conveyor to the discharge path and packing pieces not required for the subsequent further handling are guided back from the discharge path onto a tray in an internal loading device such that only required packing pieces remain on the discharge path and are provided to the subsequent further handling by the discharge path for order picking.

12. The apparatus as claimed in claim 11, wherein the trays have a frame with a peripheral raised edge and a base having at least one aperture, and wherein all the packing pieces are raised from beneath through the at least one aperture by a lifting device to a level above the edge and to the level of the discharge path, so that the unloading device can unload the packing pieces onto the discharge path using an unloading pusher.

13. The apparatus as claimed in claim 11, wherein the discharge path comprises a sensor-controlled, multi-zone conveyor arrangement, and wherein the required packing pieces are separated from the packing pieces that are not required and also singulated by the sensor-controlled, multi-zone conveyor arrangement of the discharge path.

14. The apparatus as claimed in claim 13, wherein the sensor-controlled, multi-zone conveyor arrangement of the discharge path comprises several successive conveyor zones, wherein a packing piece sensor is arranged in the region of a second conveyor zone which is shorter than a first conveyor zone and a third conveyor zone, and wherein each successive conveyor zone accelerates one or more packing pieces in a controlled manner for separation.

15. The apparatus as claimed in claim 11, wherein two tray feed sections extending in parallel in the region of the unloading device are provided, which enclose the discharge path therebetween at that location, and wherein the unloading device includes a respective unloading apparatus associated with the tray feed section and the discharge path has a loading device active on both sides.

16. The apparatus of claim 14, wherein the successive conveyor zones further comprise a fourth conveyor zone and a fifth conveyor zone.

17. A method for automatic unloading of packing pieces for automatic order picking, in which a plurality of packing pieces are provided lying on a tray upstream of further handling, said method comprising:
unloading all the packing pieces from the tray; and
reloading packing pieces onto the same or another tray that are not required for the subsequent further handling so that only packing pieces required for order picking are provided, wherein the unloading and reloading are performed by the same apparatus.

18. The method of claim 17, wherein the loading and unloading are performed by a load handler.

19. The method of claim 17, wherein the same tray is used for the reloading.
